(19) United States
(12) Patent Application Publication
(10) Pub. No.: US 2007/0201096 A1
(43) Pub. Date: Aug. 30, 2007

(54) Method of previewing printed-image and apparatus operable to executing the same

(75) Inventor: Yoshihisa Motominami, Nagano (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/708,807

(22) Filed: Feb. 20, 2007

(30) Foreign Application Priority Data
Feb. 21, 2006 (JP) 2006-043472

(51) Int. Cl. H04N 1/40

(52) U.S. Cl. 358/2.1

(57) ABSTRACT

In order to preview a printed-image which is obtained by applying an image quality adjustment with respect to an original image on the basis of a print setting, it is displayed, on a display, a first screen including the original image and print setting information indicative of the print setting. It is detected that a first operable member is operated by a user in a prescribed manner, after the first screen is displayed. It is displayed, on the display, a second screen including at least a part of the printed-image and the print setting information in place of the first screen, when the prescribed operation of the first operable member is detected.

### BACKGROUND

1. Technical Field

The present invention relates to a method of previewing a printed-image and operable to execute the same.

2. Related Art

Conventionally, there is a printer or hybrid machine (including functions of printer, scanner, copier, etc.) having a small-size display of about 1.5 to 2.5 inches. Such a printer or hybrid machine may acquire an image file from a memory card, a wireless communication device or a wired communication device, perform image processing of the image file, generate print data, and perform a printing operation such that an image can be printed without a personal computer (PC).

When the image is printed without the PC, print setting information is displayed or an image of the selected image file is displayed on the small-size display of the printer or hybrid machine. Accordingly, a user can check the image file to be printed and the print setting information without the PC. Such a technology is disclosed in Japanese Patent Publication No. 2005-111843A (JP-A-2005-111843).

There is a technology of storing, together with image data, image capturing information indicating an image capturing condition and image-processing control information for specifying an image processing condition at the time of printing an image; performing image processing such that an optimal printed image can be obtained in the printer or hybrid machine on the basis of the image capturing information and the image-processing control information; and printing the image. As such a technology, there is a print image matching (PIM) or Exif print. When the image is printed without the PC in the above-described printer or hybrid machine, an image quality adjustment based on the image capturing information and the image-processing control information is performed in the printer or hybrid machine.

However, in the related-art printer or multifunction device, the print setting information can be checked, but it is difficult to check the printed image after the image quality adjustment based on the print setting information before printing. That is, it is difficult to check the quality of the image which is actually printed on a printing sheet.

When the image quality adjustment based on the image capturing information and the image-processing control information, such as the PIM or the Exif print, is performed, since only color representation is adjusted in the image quality adjustment, it is preferable that the image after the image quality adjustment is compared with the original image. However, in the above apparatus, since the size of the display and a user interface are small, it is difficult to compare the images before and after the image quality adjustment.

For example, as described in Japanese Patent Publication No. 2005-142745A (JP-A-2005-142745), when image processing is performed on a PC, a display having a display size of about 15 inches and a high functional user interface such as a variety of operable members such as a keyboard or a mouse can be sufficiently used. However, it is difficult to perform the above-described operation using only a user interface mounted the apparatus such as the printer or hybrid machine.

### SUMMARY

It is therefore one advantageous aspect of the invention to provide a method of previewing a printed-image and operable to execute the same which are capable of checking a printed image after image quality adjustment with a small-scale user interface.

According to one aspect of the invention, there is provided a method of previewing a printed-image which is obtained by applying an image quality adjustment with respect to an original image on the basis of a print setting. The method comprises: displaying, on a display, a first screen including the original image and print setting information indicative of the print setting; detecting that a first operable member is operated by a user in a prescribed manner, after the first screen is displayed; and displaying, on the display, a second screen including at least a part of the printed-image and the print setting information in place of the first screen, when the prescribed operation of the first operable member is detected.

The method may further comprise: detecting that a second operable member is operated by the user, after the second screen is once displayed; and displaying the second screen and a third screen including at least a part of the original image alternately, every time when the operation of the second operable member is detected.

The second screen may include at least a part of the original image.

The method may further comprise: dividing the original image into a first part and a second part; and dividing the printed-image into a third part corresponding to the first part and a fourth part corresponding to the second part. The second screen may include the first part of the original image and the fourth part of the printed-image.

The method may further comprise: detecting that a second operable member is operated by the user, after the second screen is once displayed; and displaying the second screen and a third screen including the second part of the original image and the third part of the printed-image alternately, every time when the operation of the second operable member is detected.

The method may further comprise displaying, on the display, a third screen including a prescribed message after the prescribed operation of the first operable member is detected and until the second screen is displayed.

The method may further comprise: detecting that a second operable member is operated by the user; displaying, on the display, a third screen configured to change the print setting, when the operation of the second operable member is detected; detecting that a third operable member is operated by the user, after the third screen is displayed; and displaying, on the display, a screen which had been displayed when the second operable member is operated, with changed print setting information in a case where the print setting is changed.

The method may further comprise printing the printed-image based on the print setting.

According to one aspect of the invention, there is provided a program product comprising a medium storing a program operable to cause a computer to execute the above method.

According to one aspect of the invention, there is provided an apparatus operable to preview a printed-image which is obtained by applying an image quality adjustment with respect to an original image on the basis of a print setting. The apparatus comprises: a display; an operable member, adapted to be operated by a user; and a display controller, operable to display, on the display, a first screen including the original image and print setting information indicative of the print setting, and operable to display a second screen including at least a part of the printed-image and the print setting information in place of the first screen, when the operable member is operated by the user in a prescribed manner.

### BRIEF DESCRIPTION OF THE DRAWINGS

FIG. 1 is a perspective view showing a printing apparatus according to one embodiment of the invention.

FIG. 2 is an enlarged plan view showing a control panel of the printing apparatus.

FIG. 3 is a block diagram showing an electric configuration of the printing apparatus.

FIG. 4 is a block diagram showing processors which are realized by executing a prescribed computer program by a CPU shown in FIG. 3.

FIG. 5 is a flowchart illustrating the operation of the printing apparatus.

FIG. 6 is a transition diagram showing display states of a display in the printing apparatus.

FIG. 7 is a view showing an example of a default screen of the display.

FIG. 8 is a view showing an example of a zoom operation screen of the display.

FIG. 9 is a view showing an example of a wait message screen of the display.

FIG. 10 is a view showing an example of an adjusted image displaying screen of the display.

FIG. 11 is a view showing an example of an original image displaying screen of the display.

FIG. 12 is a view showing an example of a print setting screen of the display.

FIG. 13 is a view showing an example of an image selection screen of the display.

FIGS. 14 and 15 are views showing examples of adjustment previewing screens of a display in a printing apparatus according to a second embodiment of the invention.

FIG. 16 is a view showing an example of an adjustment previewing screen of a display in a printing apparatus according to a third embodiment of the invention.

FIGS. 17 and 18 are views showing examples of adjustment previewing screens of a display in a printing apparatus according to a fourth embodiment of the invention.

### DETAILED DESCRIPTION OF EXEMPLARY EMBODIMENTS

Exemplary embodiments of the invention will be described below in detail with reference to the accompanying drawings.

A printing apparatus according to a first embodiment of the invention is operable to acquire an image file from a medium such as a memory card, a wireless communication device or a wired communication device. The printing apparatus is also operable to perform image processing such as image quality adjustment with respect to image data before printing.

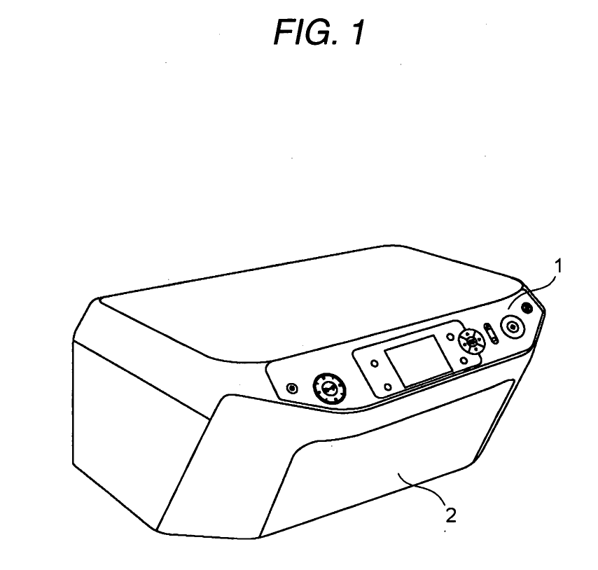

As shown in FIG. 1, the printing apparatus comprises a control panel 1 and a door cover 2 on a front face thereof. When the door cover 2 is opened, an ejection port (not shown) and a feeding port (not shown) appear.

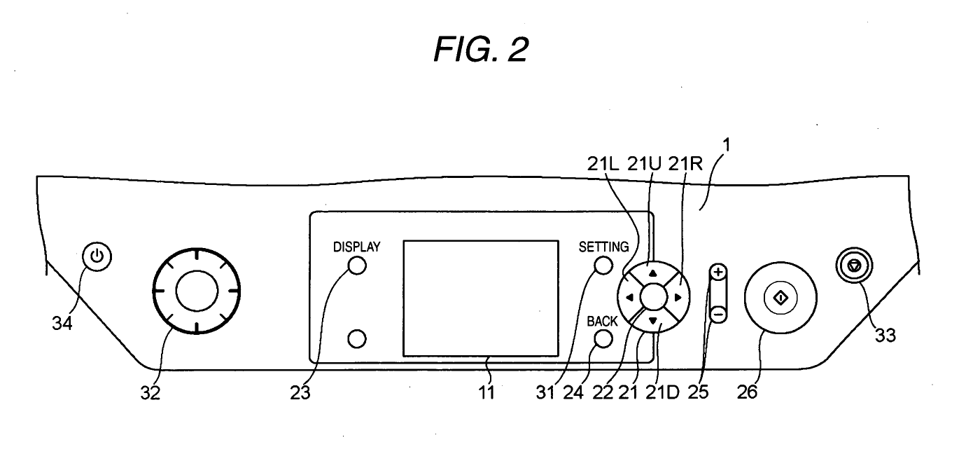

As shown in FIG. 2, the control panel 1 serves as a user interface and includes a display 11, and a cross key 21 having an up key 21U, a down key 21D, a right key 21R and a left key 21L, an OK key 22, a display switching key 23, a back key 24, a number adjusting key 25, a start key 26, a print setting key 31, a mode switching key 32, a stop key 33 and a power key 34. Each of the above keys has an electric switch operable to detect a single operation of a user so that a conduction state of the switch is changed when the switch is pressed by the user. The keys are operated when a variety of selections displayed on the display 11 is selected or a display state is changed. The cross key 21, the OK key 22, the display switching key 23 and the print setting key 31 are disposed in the vicinity of the display 11.

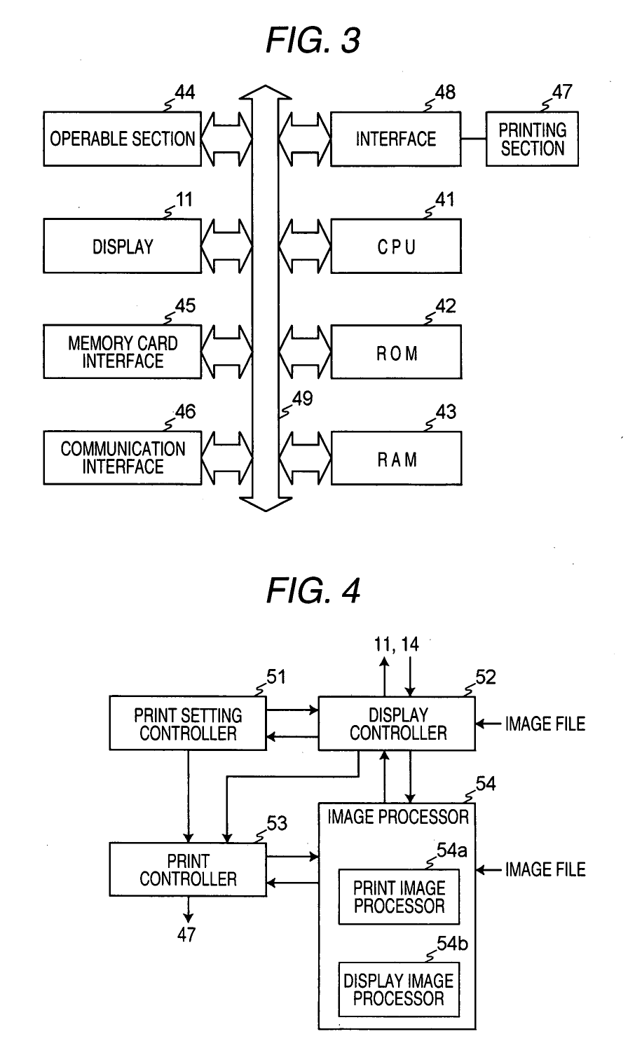

In FIG. 3, a CPU 41 is an arithmetic processor for executing a computer program to perform a process described in the computer program. A ROM 42 is a non-volatile memory such as a flash ROM for previously storing the computer program and data and is a recording medium. A RAM 43 is a memory for temporarily storing the program and data when executing the computer program.

The display 11 is a display device such as a liquid crystal display or an organic electroluminescence (EL) display having a display area of about 1.5 to 3.0 inches. An operable section 44 has a part for electrically detecting the user operation of the above-described keys.

A memory card interface 45 is an interface circuit for electrically connecting to a memory card (not shown) when the memory card is inserted. The memory card can be inserted into and extracted from the memory card interface 45. The memory card may be a SD card or a memory stick, and an image file is stored therein. The image file is, for example, a file having an Exif format including image data of joint picture experts group (JPEG) format.

A communication interface 46 is an interface circuit for connecting equipments such as a personal computer or a digital camera through a cable or wireless communication and receiving the motion image file or the still image file. The communication interface 46 is based on a wired or wireless communication standard such as a universal serial bus (USB), Bluetooth or infrared-ray communication.

A printing section 47 has a printing head for ejecting ink, a feeding/ejecting motor and a sensor for sensing the position of a printing sheet or the printing head, so that an image is printed onto the printing sheet.

An interface 48 is an interface circuit which is electrically connected to elements of the printing section 47 and supplies a control signal to the printing section 47 or acquires a sensor signal from the printing section 47.

A bus 49 is a path for connecting the CPU 41, the ROM 42, the RAM 43, the operable section 44, the display 11, the memory card interface 45, the communication interface 46 and the interface 48 with one another. The CPU 41 communicates data with the operable section 44, the display 11, the memory card interface 45, the communication interface 46 and the interface 48 by way of the bus 49. The form of the bus 49 is not limited to that shown in FIG. 3.

A large-scale data storage device for storing the image file may be connected to the bus 49 and used instead of or together with the memory card interface 45 and the memory card. Such a large-scale data storage device may be a hard disc drive or a disc driver into which an optical disc media is inserted.

When the CPU loads and executes the computer program stored in the ROM 42, the processors having a variety of functions are realized as shown in FIG. 4.

A print setting controller 51 is a processor for managing print setting information, specifying print setting of each print image on the basis of the default print setting information which is stored in advance in the ROM 42 and print setting which is individually input to each print image through the operable section 44, and supplying the print setting information to a display controller 52 and a print controller 53.

The display controller 52 is a processor for controlling the display 11 to display a variety of information such as characters or images on the display 11 and transiting a display state of the display 11 on the basis of a user operation at the operable section 44.

The print controller 53 is a processor for performing a print processing of an image generated by an image processor 54. The print controller 53 controls the printing section 47 through the interface 48 to perform the print processing using the image processor 54 and prints an image on a printing sheet.

The image processor 54 includes a print image processor 54a and a display image processor 54b. The print image processor 54a is a processor for performing image processing such as an image quality adjustment, a color conversion and a halftoning with respect to image data in an image file, in order to print an image. The display image processor 54b is a processor for performing the image processing such as an image quality adjustment with respect to image data in an image file, in order to display an image. When image capturing information and image-processing control information are included in the image file, the print image processor 54a performs the image quality adjustment on the basis of the image capturing information and the image-processing control information to generate an image to be printed (print image). When image capturing information and image-processing control information are included in the image file, the display image processor 54b performs the image quality adjustment on the basis of the image capturing information, the image-processing control information and display correction data to generate a print image to be displayed (displayed print image). The display correction data is data for correcting image control information such that the print image which is actually printed and the displayed print image which is displayed on the display 11 are equally viewed, and is stored in advance in the ROM 42 because the display correction data is inherent in each type. The image-processing control information stored in the image file is used for the printer, but not for the display. In addition, since the printer and the display adopt different color representations, the image-processing control information needs to be corrected in order to display the image having the same texture as the print image, and such correction information is thus included in the display correction data.

Moreover, as the image processing of the print image processor 54a, for example, an apparatus disclosed in Japanese Patent Publication No. 2002-344989A (JP-A-2002-344989) may be used. As the image processing of the display image processor 54b, for example, an apparatus disclosed in Japanese Patent Publication No. 2005-167929 (JP-A-2005-167929) may be used.

The print image processor 54a analyzes the image data, acquires an image statistic value (characteristic parameter value) indicating the characteristics of the image data, determines an automatic image quality adjustment parameter on the basis of a deviation between a prescribed reference parameter value and the image statistic value and the image-processing control information, in the image quality adjustment. The print image processor 54a adjusts the quality of the image data on the basis of the automatic image quality adjustment parameter. The automatic image quality adjustment parameter may include parameters such as shadow, highlight, brightness, contrast, color balance, memory color and so on.

The print image processor 54a performs the image quality adjustment using tone curves (S curves) for enabling correspondences between input levels and output levels of RGB components of the image data, with respect to the automatic image quality adjustment parameters such as the shadow, the highlight, the brightness, the contrast, the color balance and the memory color correction. When the image quality is adjusted using the tone curve, the tone curves of the RGB components are changed using the values of the automatic image quality adjustment parameters and the RGB components of the image data are corrected using the changed tone curves of the RGB components. Accordingly, the image data of which the image quality is adjusted is obtained.

The image quality adjustment based on the automatic image quality adjustment parameters are, for example, performed as follows. With respect to contrast, the shadow and the highlight, a shadow point and a highlight point are detected from the image data and all the levels are corrected on the basis of the values of the shadow point and the highlight point. The tone curves are corrected on the basis of a brightness standard deviation.

With respect to the brightness, it is determined whether the image is dark (insufficient exposure) or bright (excessive exposure) on the basis of the brightness value calculated from areas obtained by dividing the image data by 14 and the tone curves are corrected according to the determined result.

With respect to the color balance, deflection of the color balance is analyzed from a histogram of the RGB components of the image data and the tone curves of the RGB components are corrected. Accordingly, color fogging decreases.

With respect to color saturation, a color saturation distribution of the image data is analyzed and thus the color saturation is emphasized according to the color saturation distribution. Accordingly, as the color saturation of the image data decreases, the level of the color saturation emphasis increases.

With respect to sharpness, different unshaping masks are used in the landscape having a high spatial frequency and the person having a low spatial frequency.

With respect to the memory color, images corresponding to “flesh color”, “green”, “sky blue”, “sunset red” called the memory color are extracted from the image data and corrected to become a preferred colors as the memory color.

In the color conversion, color spaces of the image data after the image quality adjustment are converted into CMYK color spaces and converted into the color spaces corresponding to the types of the inks used for printing. In the halftoning, the number of gradations of the image data after the color conversion is changed. For example, the image data after the color conversion becomes data of 256 gradations for each color. Meanwhile, since data of two gradations indicating existence of the dot upon printing is used at the time of printing, the gradation is changed. As the method of changing the gradation, there is an error diffusion method or an ordered dither method.

Meanwhile, the display image processor 54b corrects the value of the automatic image quality adjustment parameter on the basis of display correction data and performs image quality adjustment using the value of the automatic image quality adjustment parameter after correction in the image quality adjustment.

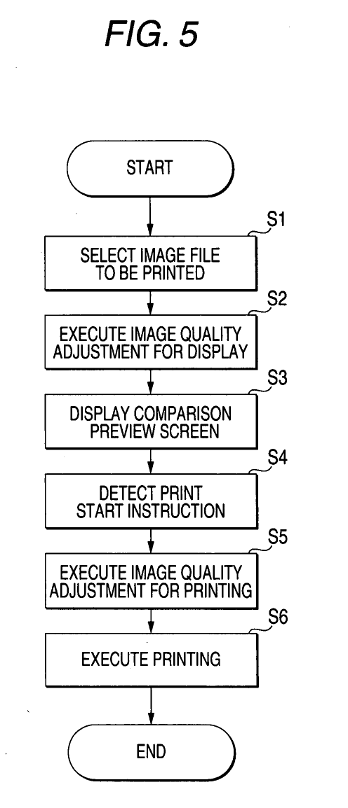

Next, the operation of the printing apparatus will be described with reference to FIG. 5.

First, the CPU 41 loads and executes a prescribed computer program stored in the ROM 42. Accordingly, the processors shown in FIG. 4 are realized.

Next, in a case of using a memory card, the display controller 52 acquires a list of image files in the memory card through the memory card interface 45 and displays a list of names of the image files on the display 11. Thereafter, the display controller 52 monitors the state of the operable section 44, waits for the user operation of the operable section 44, detects the selection of the user, and selects the image file according to the selection (step S1).

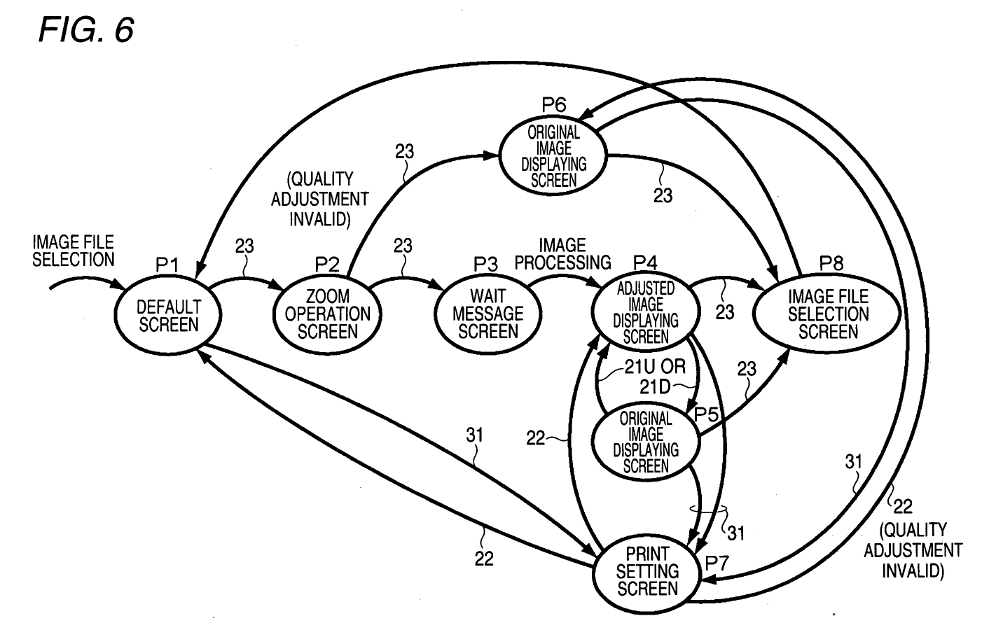

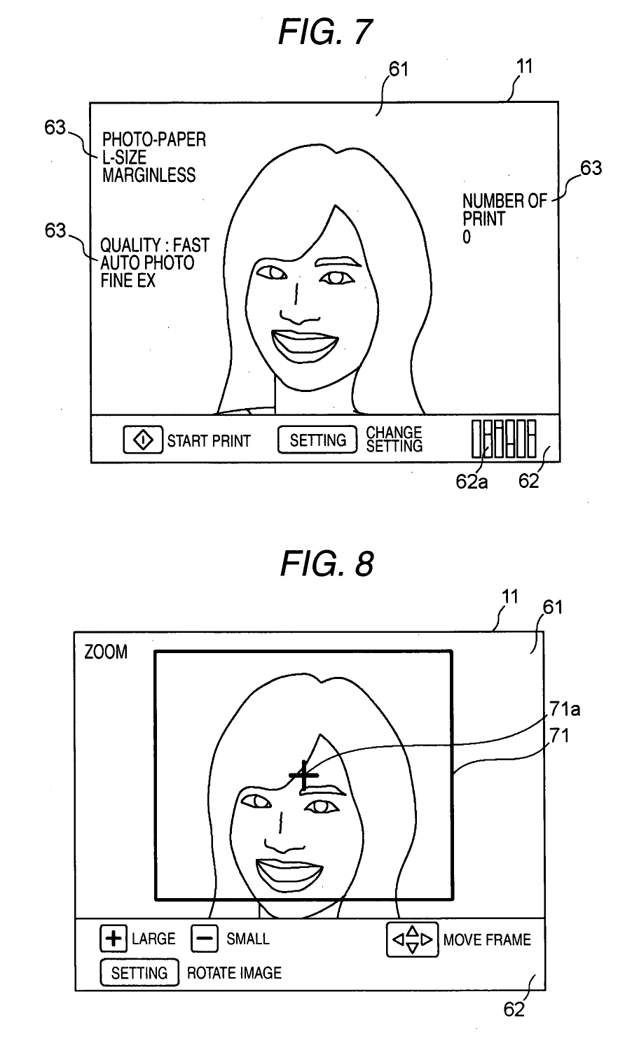

When the image file is selected, the display controller 52 displays an original image together with the print setting information at the time point on the display 11 on the basis of the image data of the image file (state P1) as shown in FIG. 6. At the state P1, as shown in FIG. 7, the original image 61, the operation help screen 62 and the print setting information 63 are displayed. The operation help screen 62 and the print setting information 63 are displayed to overlap the original image 61 in the vicinity of the edges of a display area of the display 11. Accordingly, a part of the original image 61 is hidden. In addition, the displayed print setting information 63 is a part or all of the print setting information such as a sheet type, a sheet size, a print layout, print quality, image quality adjustment and the number of print. At the state P1, as the operation help screen 62, a print start operation is assigned to the start key 26 and a print setting change operation is assigned to the print setting key 31. At the state P1, an ink indicator 62a indicating the residual amount of ink of each color is displayed together with the operation help screen 62.

When the display switching key 23 is pressed at the state P1 (FIG. 7), the display controller 52 detects the pressing of the display switching key 23 and transits the display state of the display 11 to a state P2 as shown in FIG. 6.

At the state P2, as shown in FIG. 8, the display screen of the display 11 becomes a zoom operation screen. At this time, the display controller 52 displays the operation help screen 62 and a zoom range image 71 to overlap the original image 61. The zoom range image 71 has a center display mark 71a at the center of a frame. The display controller 52 expands/reduces in size or rotates the image 61 when the prescribed operable section 44 operates as the operation help screen. That is, when a “+” key of the number adjusting key 25 is pressed, the image 61 is expanded on the basis of the position of the center display mark 71a, when a “−” key of the number adjusting key 25 is pressed, the image 61 is reduced in size on the basis of the position of the center display mark 71a, and, when the print setting key 31 is pressed, the image rotates on the basis of the position of the center display mark 71a. When the cross key 21 is pressed, the display controller 52 moves the zoom range image 71 in a direction corresponding to the pressed key.

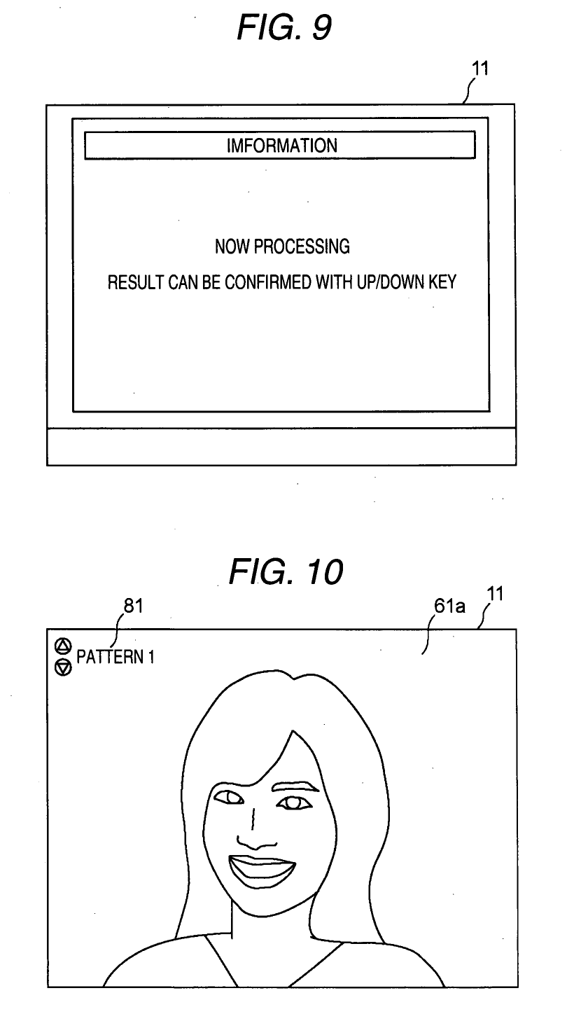

When the display switching key 23 is pressed at the state P2 (FIG. 8) similar to the transition from the state P1 to P2, the display controller 52 detects the pressing of the display switching key, refers to the print setting information, and transits the display state of the display 11 to a state P3 as shown in FIG. 6 when the image quality adjustment is valid. When the operation except for the pressing of the display switching key 23 is not performed at the state P2, the original image 61 is not specially changed. The display controller 52 performs the image quality adjustment for displaying the image data with respect to the display image processor 54b at the state P3. In this case, the display image processor 54b performs the image quality adjustment for display on the basis of the print setting information, with respect to the image data of the original image 61 (including the image after the zooming operation at the state P2) (step S2). Since several seconds are needed for the image quality adjustment, the display controller 52 displays a wait message shown in FIG. 9 until the image quality adjustment is completed.

When the image quality adjustment of the display image processor 54b is completed, the display controller 52 automatically transits the display state of the display 11 to a state P4 without the user operation as shown in FIG. 6. At the state P4, a displayed print image 61a which is subjected to the image quality adjustment for display is displayed on the display 11 as shown in FIG. 10. At this time, the print setting information 63 of the state P1 (FIG. 1) is not displayed to overlap the print image 61a but an image 81 indicating information such as the state and the type of the image quality adjustment is displayed on a corner of the display 11. The image 81 shown in FIG. 10 includes images having the same shapes as the up and down keys 21U and 21D.

That is, when the display switching key 23 is pressed twice from the display of the original image 61 and the print setting information 63 of the state P1, the image which is obtained by performing the image quality adjustment with respect to image 61 displayed at the state P1 on the basis of the print setting information is displayed as the displayed print image 61a of the state P4 through the state P3.

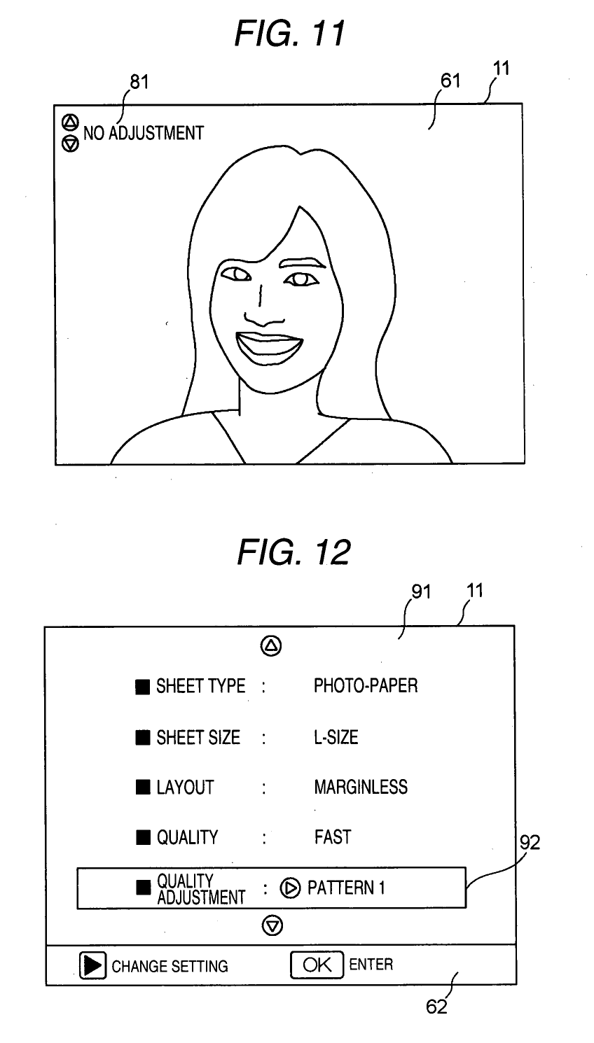

When any one of the up and down keys 21U and 21D is pressed at the state P4 (FIG. 10), the display controller 52 detects the pressing of the up or down key and transits the display state of the display 11 to a state P5 as shown in FIG. 6. At the state P5, the original image 61 (or the image after zooming operation at the state P2) is displayed on the display 11 as shown in FIG. 11. At this time, similar to the state P4 (FIG. 10), the print setting information 63 is not displayed and the image 81 indicating the image before the image quality adjustment is displayed on a corner of the display 11.

When any one of the up and down keys 21U and 21D is pressed at the state P5 (FIG. 11), the display controller 52 detects the pressing of the up or down key and transits the display state of the display 11 to the state P4 as shown in FIG. 6. Accordingly, whenever any one of the up and down keys 21U and 21D of the cross key 21 is pressed, the display state of the display 11 alternatively transits between the state P4 and the state P5 so that the original image 61 and the displayed print image 61a are alternatively displayed (step S3).

Since the original image 61 and the displayed print image 61a are alternatively displayed whenever the up or down key is pressed, preview between the both images is possible.

Meanwhile, when the display switching key 23 is pressed at the state P2 (FIG. 8) similar to the transition from the state P1 to the state P2 and the image quality adjustment is invalid, the display controller 52 transits the display state of the display 11 to a state P6 as shown in FIG. 6 and displays the original image 61 on the display 11 similar to the state P5.

When the images 61 and 61a are desired to be printed at the states P1, P4, P5 and P6, the user presses the start button 26. When the display controller 52 detects that operation (step S4), the display controller allows the print controller 53 to start the print processing of the image. The print controller 53 controls the printing section 47 through the interface 48 to perform the print processing while allowing the print image processor 54a to perform image processing for printing (step S5) and prints the print image on the medium such as the printing sheet (step S6).

Meanwhile, when the print setting key 31 is pressed at the states P1, P4, P5 and P6, the display controller 52 detects the pressing of the print setting key and transits the display state of the display 11 to a state P7 as shown in FIG. 6. At the state P7, the print setting can be changed. As shown in FIG. 12, on a print setting screen, a menu 91 of the printing setting information at this time is displayed and the operation help screen 62 is displayed. When the up or down key 21U and 21D is pressed at the state P7, the display controller 52 detects the pressing of the up or down key and moves and displays a cursor frame image 92 in the screen upward or downward. When the right key 21R of the cross key 21 is pressed, the display controller 52 detects the pressing of the right key, switches the value of the print setting item of the cursor frame image 92 in the menu 91, and applies the switch of the value to the display of the display 11. When the right key 21R is pressed at the state shown in FIG. 12, selections (“Pattern 1”, “Pattern 2”, and “Off”) are sequentially displayed according to the number of pressings such that the type of the image quality adjustment is changed or the image quality adjustment is turned off.

When the change of the print setting information is completed, the user presses the OK key 22 so as to decide the change. When the display controller 52 detects the operation, the display controller 52 returns the display state of the display 11 to the state before transiting to the state S7 and applies the change to the display contents of each state. That is, when the state P7 is returned to the state P1, the print setting information 63 after the change is displayed. When the state P7 is turned to the states P4, P5 and P6 and the image quality adjustment is valid, the display controller 52 transits the display state of the display 11 to the state P4 (or the state p4 through the stat P3), allows the display image processor 54b to generate the data of the image 61a which is subjected to the image quality adjustment with the setting after the change, and displays the image 61a on the display 11. When the state P7 is turned to the states P4, P5 and P6 and the image quality adjustment is invalid, the display controller 52 transits the display state of the display 11 to the state P6 and displays the original image 61 on the display 11.

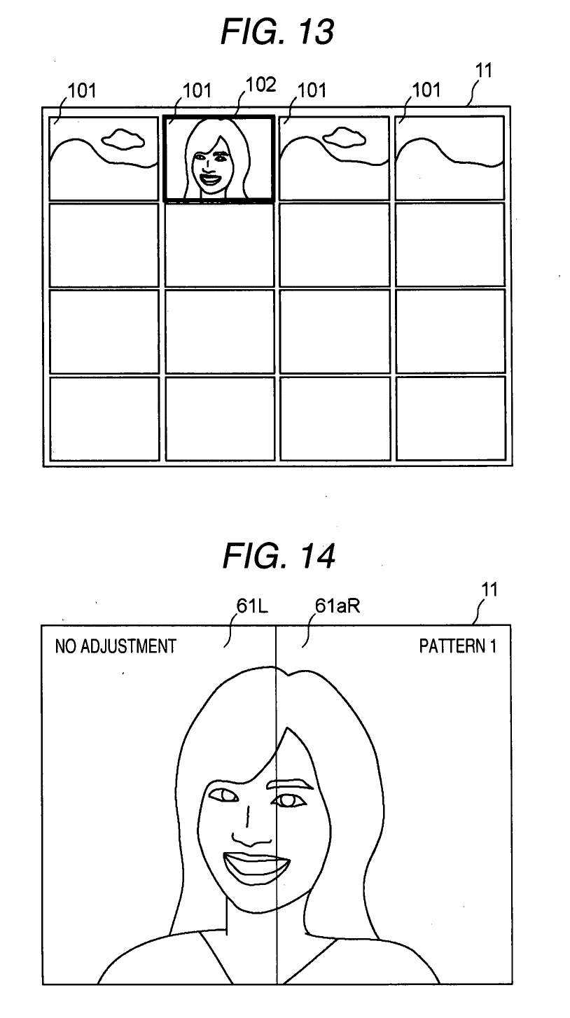

When the display switching key 23 is pressed at the states P4, P5 and P6, the display controller 52 detects the pressing of the states and transits the display state of the display to a state P8 as shown in FIG. 6. At the state P8, the image file to be printed can be selected and changed. At the state P8, for example, at least one thumbnail image 101 of at least one image file in the memory card is displayed and a cursor frame image 102 is also displayed as shown in FIG. 13. When any operation of the cross key 21 is detected at the state P8, the display controller 52 moves and displays the cursor frame image 102 in a direction corresponding to the key. When the display switching key 23 is pressed at the state P8, the display controller 52 detects the pressing of the display switching key, selects the image file of the thumbnail image 101, at which the cursor frame image 102 is located, as an image to be printed, transits the display state of the display 11 to the state P1, and displays the original image 61 of the selected image file and the print setting information 63 on the display 11. The next operations are similar to the above-described operations. Accordingly, when the display switching key 23 is repetitively pressed, the display state of the display 11 is cyclically changed in order of the states P1, P2, P3 (or P6) and P8.

As described above, in this embodiment, the user interface includes the display 11 and the display switching key 23 for receiving the user operation and changing an electrical state according to the user operation. The display controller 52 displays the original image 61 to be printed and the print setting information 63 on the display 11, performs the image quality adjustment based on the print setting information 63 with respect to the original image 61 when a prescribed number of operations for the display switching key 23 is detected after displaying the original image 61, and displays the displayed print image 61a, which is similar to the print image, on the display 11. Accordingly, the print setting can be checked by simply operating only the small-scaled user interface of the apparatus, such as the display 11 and the display switching key 23, and the print image (image printed on the printing sheet) after the image quality adjustment based on the print setting can be surely checked on the display 11 as the displayed print image 61a.

In this embodiment, the display controller 52 detects the operation of the up and down keys 21U and 21D after displaying the displayed print image 61a and displays any one of the displayed print image 61a and the original image 61 on the display 11 according to the operation. Since the displayed print image 61a and the original image 61 are alternatively displayed by merely operating the up and down keys 21U and 21D, a subtle difference between the displayed print image 61a and the original image 61, that is, the effect of the image quality adjustment, can be surely checked.

In this embodiment, the display controller 52 detects a prescribed number (two) of operations for the display switching key 23 after displaying the original image 61, performs the image quality adjustment of the original image 61, and displays a prescribed message on the display 11 until the displayed print image 61a is displayed. Accordingly, it is possible to reduce stress of the user due to a waiting time of the image quality adjustment by displaying the message such as a current processing state or a next operation help screen on the display screen.

In this embodiment, the display controller 52 detects the operation for the print setting key 31, sets the display screen of the display 11 to a setting screen, detects the operation for the OK key 22, returns the display screen of the display 11 to a screen displayed before the operation for the print setting key 31, and updates the displayed print image 61a in the screen to the displayed print image 61a according to the print setting information changed on the setting screen. Accordingly, it is possible to perform the change of the print setting by a simple operation and to immediately check the change of the print setting.

Next a second embodiment of the invention will be described. In this embodiment, the display screens of the state P4 and the state P5 are different from the first embodiment. The explanation will be provided in connection with this point, and any other repetitive explanations will be omitted.

In this embodiment, an image obtained by synthesizing the original image 61 (image after the zooming operation when it is performed) and the displayed print image 61a is displayed at the state P4. In the image after synthesis, the original image 61 is displayed at one half of the screen and the displayed print image 61a is displayed at the other half of the screen. That is, at the state P4, the image which is subjected to the image quality adjustment is displayed in a part (partial area) of the original image 61 on the display 11. At the state P5, the area in which the original image 61 was displayed at the state P4 becomes the area for the displayed print image 61a and the area in which the displayed print image 61a was displayed at the state P4 becomes the area for the original image 61.

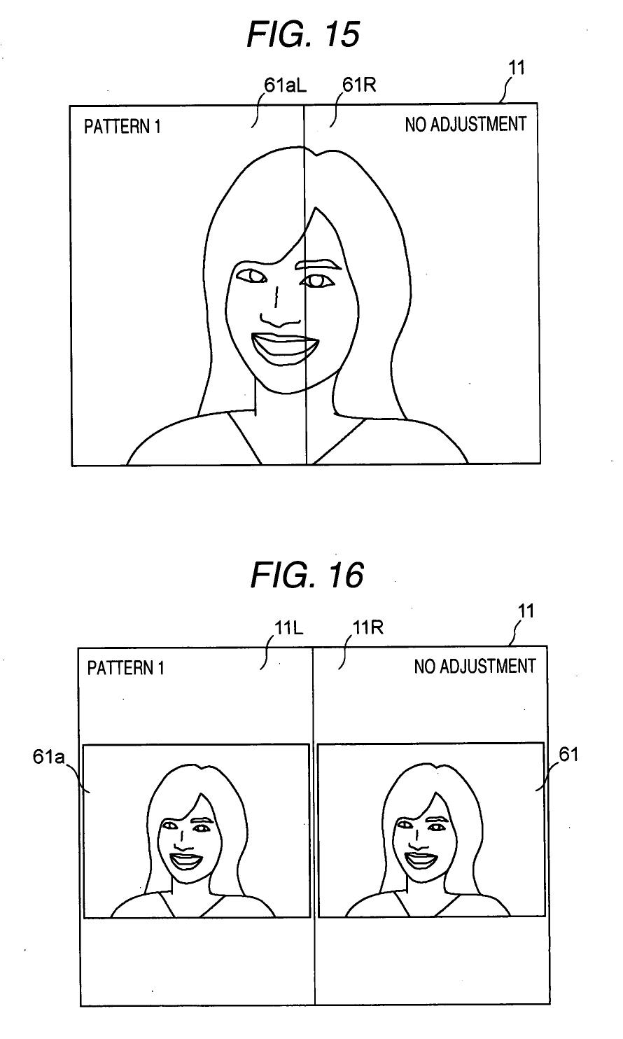

As shown in FIG. 14, at the state P4, a left area 61L of the original image 61 is displayed in the left half of the display 11 and a right area 61aR of the displayed print image 61a is displayed in the right half of the display 11. As shown in FIG. 15, at the state P5, a left area 61aL of the displayed print image 61a is displayed in the left half of the display 11 and a right area 61R of the original image 61 is displayed in the right half of the display 11. Vertical lines located at the centers of FIGS. 14 and 15 are drawn for convenience of description and may be omitted.

As described above, in this embodiment, the display controller 52 combines and displays a first division area 61aL (61aR) of first and second division areas 61aL and 61aR obtained by dividing the displayed print image 61a and the area 61R (61L) of the original image 61 corresponding to the second division area when the print mage 61a for display. Accordingly, as shown in FIGS. 14 and 15, since a subject can be viewed to be continued between the first and second division areas as the entire image, it is possible to surely check the change in impression of the image due to the image quality adjustment.

In this embodiment, the display controller 52 detects the operation for the up and down keys 21U and 21D after displaying the displayed print image 61a (partial area 61aR), alternatively selects the first division area 61aL and the second division area 61aR of the displayed print image 61a according to the operation, combines and displays one division area 61aL (61aR) selected from the displayed print image 61a and the area 61R (61L) of the original image 61 corresponding to the other division area. Accordingly, since the subject can be viewed to be continued between the first and second division areas 61L and 61aR or 61aL and 61R as the entire image and the area which is subjected to the image quality adjustment in the entire area of the displayed image can be switched by the up and down keys 21U and 21D, it is possible to surely check the change in impression of the image due to the image quality adjustment over the entire area.

Next a third embodiment of the invention will be described. In this embodiment, the display screens of the state P4 and the state P5 are different from the first embodiment. The explanation will be provided in connection with this point, and any other repetitive explanations will be omitted.

In this embodiment, two images including the original image 61 (the image after the zooming operation when it is performed) and the displayed print image 61a are displayed at the state P4. As shown in FIG. 16, at the state P4, the entire area of the displayed print image 61a is displayed in a left half display area 11L of the display 11 and the entire area of the original image 61 is displayed in a right half display area 11R.

Since the original image 61 and the displayed print image 61a are simultaneously displayed and compared, it is possible to surely check the change in impression of the image due to the image quality adjustment over the entire image.

Next a fourth embodiment of the invention will be described. In this embodiment, the display screens of the state P4 and the state P5 are different from the third embodiment. The explanation will be provided in connection with this point, and any other repetitive explanations will be omitted.

In this embodiment, at the state P4, two images including a part of the original image 61 (the image after the zooming operation when it is performed) and a part of the displayed print image 61a corresponding thereto are displayed. At the state P5, two images including the other part of the original image 61 (the image after the zooming operation when it is performed) and the other part of the displayed print image 61a corresponding thereto are displayed.

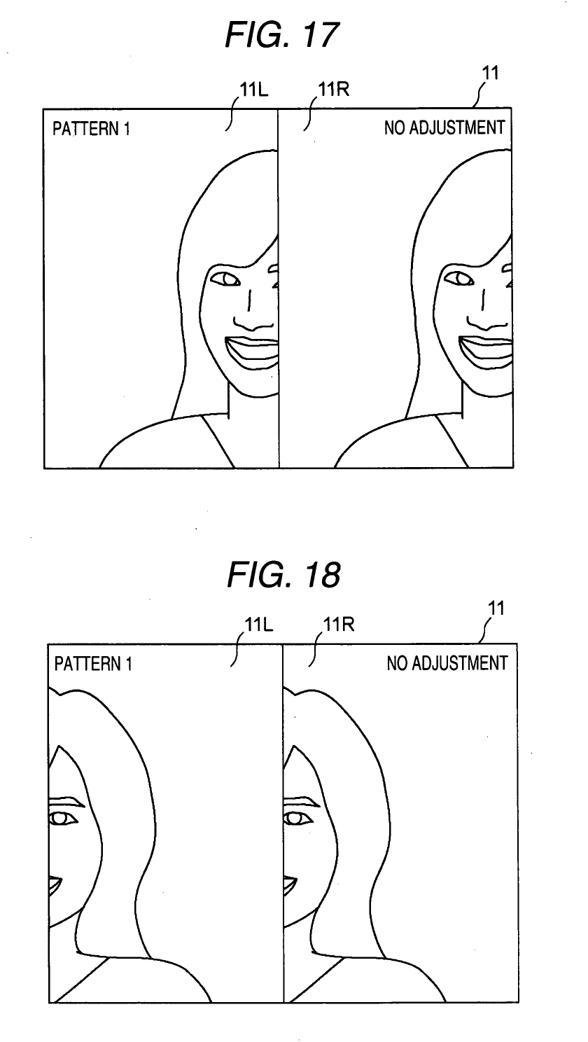

As shown in FIG. 17, at the state P4, a left half area of the displayed print image 61a is displayed in a left half display area 11L of the display 11 and a left half area of the original image 61 is displayed in the right half display area 11R. As shown in FIG. 18, at the state P5, a right half area of the displayed print image 61a is displayed in a left half display area 11L of the display 11 and a right half area of the original image 61 is displayed in the right half display area 11R.

As the examples shown in FIGS. 17 and 18, when the display area of the display 11 is divided into left and right display areas 11L and 11R such that the parts of the image are displayed to be compared, the operable section 44 assigned to the state transits between the state P4 and the state P5 may be the left and right keys of the cross key 21 instead of the up and down keys. In the examples shown in FIGS. 17 and 18, although the display area of the display 11 is divided into left and right display areas 11L and 11R such that the parts of the image are displayed to be compared, the display area of the display is divided into upper and lower areas such that upper and lower parts of the images 61 and 61a may be displayed to be compared.

Although the parts which are displayed to be compared are parts of the images 61 and 61a in the states P4 and P5, the entire area of the image is printed.

As described above, in this embodiment, when the displayed print image 61a is displayed, the display controller 52 simultaneously displays the parts of the displayed print image 61a and the original image 61 on the display 11 to be compared. Accordingly, since the compared parts can be simultaneously viewed, the subtle difference between the displayed print image 61a and the original image 61, that is, the effect of the image quality adjustment, can be surely checked.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For example, in the state P4 of the embodiment, the zoom operation such as the state P2 may be performed so that the original image 61 and the displayed print image 61a may be compared with respect to the area selected by the user. Even in this case, the entire image including the compared part is printed at the time of printing.

In the above embodiments, the displayed print image 61a after the image quality adjustment is displayed when the display switching key 23 is pressed twice, the display state of the display 11 may directly transit to the state P4 such that the displayed print image 61a is displayed, when the display switching key 23 is pressed once at the state P1, that is, the state P2 may be omitted. Alternatively, when the up and down keys 21U and 21D are pressed in the state P1, the display state of the display 11 may transit to the state P4. Alternatively, when a preview key is separately provided in the control panel 1 and is pressed, the display state of the display may transition to the state P4. Even in some cases, the display state of the display 11 can transit from the state P1 to the state P4 by operating one operable member (operation key) by a prescribed number.

In the above embodiments, at the state P4 and P5, the display position of the image 81 may be moved by the display controller 52 according to the operation of the operable member. In this case, a part of the images 61 and 61a hidden by the image 81 can be viewed. In the cross key 21, the keys except for the keys used for transition between the state P4 and the state P5 may be used as the operable member for performing such operation.

The disclosure of Japanese Patent Application No. 2006-43472 filed Feb. 21, 2006 including specification, drawings and claims is incorporated herein by reference in its entirety.

What is claimed is:

1. A method of previewing a printed-image which is obtained by applying an image quality adjustment with respect to an original image on the basis of a print setting, the method comprising:
displaying, on a display, a first screen including the original image and print setting information indicative of the print setting;
detecting that a first operable member is operated by a user in a prescribed manner, after the first screen is displayed; and
displaying, on the display, a second screen including at least a part of the printed-image and the print setting information in place of the first screen, when the prescribed operation of the first operable member is detected.

2. The method as set forth in claim 1, further comprising:
detecting that a second operable member is operated by the user, after the second screen is once displayed; and
displaying the second screen and a third screen including at least a part of the original image alternately, every time when the operation of the second operable member is detected.

3. The method as set forth in claim 1, wherein:
the second screen includes at least a part of the original image.

4. The method as set forth in claim 1, further comprising:
dividing the original image into a first part and a second part; and
dividing the printed-image into a third part corresponding to the first part and a fourth part corresponding to the second part, wherein:
the second screen includes the first part of the original image and the fourth part of the printed-image.

5. The method as set forth in claim 4, further comprising:
detecting that a second operable member is operated by the user, after the second screen is once displayed; and
displaying the second screen and a third screen including the second part of the original image and the third part of the printed-image alternately, every time when the operation of the second operable member is detected.

6. The method as set forth in claim 1, further comprising:
displaying, on the display, a third screen including a prescribed message after the prescribed operation of the first operable member is detected and until the second screen is displayed.

7. The method as set forth in claim 1, further comprising:
detecting that a second operable member is operated by the user;
displaying, on the display, a third screen configured to change the print setting, when the operation of the second operable member is detected;
detecting that a third operable member is operated by the user, after the third screen is displayed; and
displaying, on the display, a screen which had been displayed when the second operable member is operated, with changed print setting information in a case where the print setting is changed.

8. The method as set forth in claim 1, further comprising:
printing the printed-image based on the print setting.

9. A program product comprising a medium storing a program operable to cause a computer to execute the method as set forth in claim 1.

10. An apparatus operable to preview a printed-image which is obtained by applying an image quality adjustment with respect to an original image on the basis of a print setting, the apparatus comprising:
a display;
an operable member, adapted to be operated by a user; and
a display controller, operable to display, on the display, a first screen including the original image and print setting information indicative of the print setting, and operable to display a second screen including at least a part of the printed-image and the print setting information in place of the first screen, when the operable member is operated by the user in a prescribed manner.
